(19) United States
(12) Patent Application Publication
(10) Pub. No.: US 2005/0114016 A1
(43) Pub. Date: May 26, 2005

(54) Navigation system and method for updating map data based on map modification command

(75) Inventors: Sung-Dong Kim, Suwon-si (KR); Hyun-Suk Min, Seoul (KR); Sung-Chui Yang, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/935,604

(22) Filed: Sep. 7, 2004

(30) Foreign Application Priority Data
Nov. 25, 2003 (KR) 84075/2003

(51) Int. Cl. G01C 21/32

(52) U.S. Cl. 701/208; 340/995.12

(57) ABSTRACT

A navigation system including a map data server and a navigation terminal. The map data server stores map data produced for the map information of a specific region. When an external manager modifies the map data, the server produces and transmits map modification command information corresponding to the modified map data. The navigation terminal stores map data corresponding to the map data stored in the map data server, receives and analyzes the map modification command information, and modifies the previously stored map data according to the analyzed result. Therefore, map data can be updated using the small amount of map modification command data.

### PRIORITY

This application claims priority to an application entitled “NAVIGATION SYSTEM AND METHOD FOR UPDATING MAP DATA BASED ON MAP MODIFICATION COMMAND”, filed in the Korean Intellectual Property Office on Nov. 25, 2003 and assigned Serial No. 2003-84075, the contents of which are hereby incorporated by reference.

### BACKGROUND OF THE INVENTION

1. Field of the Invention

The present invention relates generally to a navigation system and method, and more particularly to a navigation system and method for updating map data.

2. Description of the Related Art

Commonly, a navigation system is installed in various moving bodies such as a ship, an aircraft, or a vehicle to inform a driver of the current location of the moving body, to calculate an optimal route to a desired destination, and to direct the driver according to the calculated route. A navigation terminal generally stores map data, and uses the stored map data to provide a visual guide of an optimal route to the destination. More specifically, the navigation terminal stores information of roads, buildings, and/or facilities as numerical map data in a specific format. Then, the navigation terminal matches location information received from a GPS satellite with the previously stored map data, so as to show an optimal route for the moving vehicle to the destination through a screen in the moving vehicle. However, the roads, buildings, facilities, etc., frequently change. As a result, the map data of the navigation terminal must be frequently updated to reflect the changed roads, buildings, facilities, etc.

FIG. 1 illustrates a method for updating map data in the conventional navigation system, and FIG. 2 illustrates a structure of the conventional map data. As illustrated in FIG. 1, the conventional navigation system for updating map data includes a navigation terminal 10, which is installed in a vehicle, and a map data server 40 for providing updated map data to the navigation terminal 10 over a wireless network 30. The map data server 40 produces the map information of a specific area, and stores the map data. As illustrated in FIG. 2, the specific area is divided into N cells, in which each divided cell is assigned its own address. If the file size of each divided cell is larger than a size transmittable over the wireless network 30, each divided cell is subdivided into smaller-sized cells. Then, it is again determined if the size of each subdivided cell is larger than the transmittable size. If the size of each subdivided cell is larger than the transmittable size, each cell is repeatedly subdivided so that all the cells have the size transmittable over the wireless network. Accordingly, the server 40 stores the map data such that an entire map data area 44 is divided into cell areas, as illustrated in FIG. 1. If data of cell areas 2 as a part of the entire map data area 44 is updated, the map data server 40 transmits the entire data of the cell areas 2 including the updated data to the navigation terminal 10 over the wireless network 30.

The navigation terminal 10 receives the entire data of the cell areas 2 including the updated data from the map data server 40 over the wireless network 30, and updates the entirety of corresponding cell areas in an entire map data area 14 previously stored in the terminal 10.

However, in the conventional map data update method as described above, the navigation terminal 10 must download the entire data of the updated cell areas 2 to update the map data. This requires that the navigation terminal 10 download a large amount of data, and thus the user pay higher usage fees for the wireless network.

### SUMMARY OF THE INVENTION

Therefore, the present invention has been designed in view of the above and other problems, and it is an object of the present invention to provide a navigation system and method for updating map data by downloading a smaller amount of data.

It is another object of the present invention to provide a navigation system and method, wherein a small amount of map modification command information is downloaded, and previously stored map data is modified based on the map modification command information.

In accordance with the present invention, the above and other objects can be accomplished by a navigation system comprising a map data server for storing map data of a specific region, and, when an external manager modifies the map data, producing and transmitting map modification command information corresponding to the modified map data; and a navigation terminal for storing map data corresponding to the map data stored in the map data server, receiving the map modification command information, and modifying the stored map data according to the map modification command information.

### BRIEF DESCRIPTION OF THE DRAWINGS

The above and other objects, features, and advantages of the present invention will be more clearly understood from the following detailed description taken in conjunction with the accompanying drawings, in which:

FIG. 1 illustrates a method for updating map data in a conventional navigation system;

FIG. 2 illustrates a structure of the conventional map data;

FIG. 3 is a block diagram illustrating a navigation system according to an embodiment of the present invention;

FIG. 4 is a flow chart illustrating a method for updating map data in a navigation system according to an embodiment of the present invention;

FIG. 5 is a block diagram illustrating a map data server according to an embodiment of the present invention;

FIGS. 6 and 7 illustrate examples of map data stored in the map data server according to an embodiment of the present invention;

FIG. 8 is a flow chart illustrating a method for transmitting map modification command information according to an embodiment of the present invention;

FIG. 9 is a block diagram illustrating a navigation terminal according to an embodiment of the present invention;

FIG. 10 illustrates an example of map modification reference information stored in the navigation terminal according to an embodiment of the present invention; and

FIG. 11 is a flow chart illustrating a method for modifying map data in the navigation terminal according to an embodiment of the present invention.

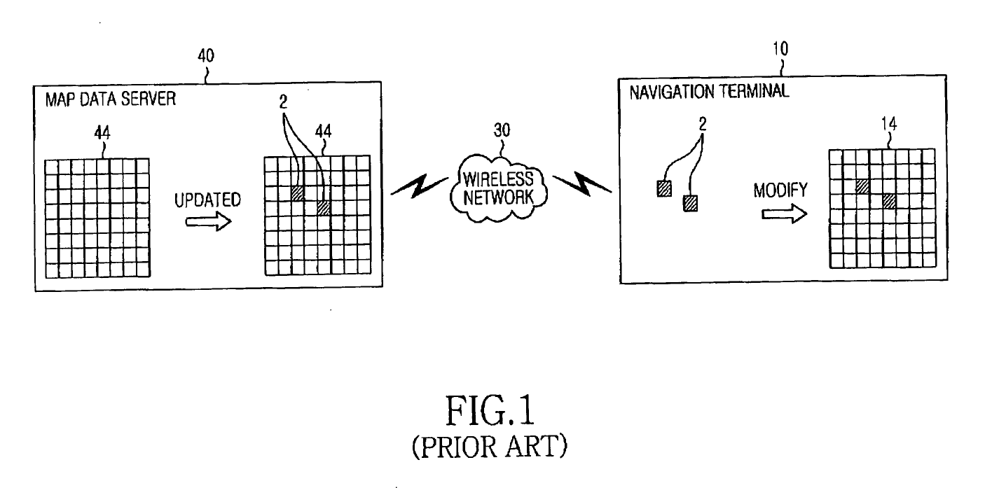

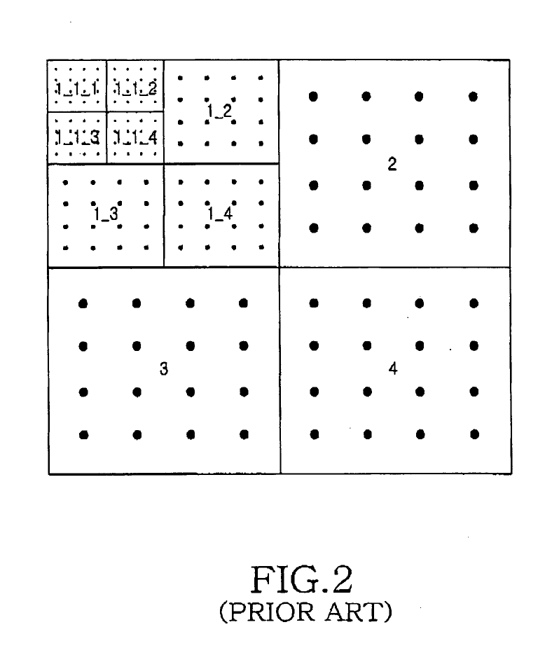

### DETAILED DESCRIPTION OF THE PREFERRED EMBODIMENTS

Preferred embodiments of the present invention will be described in detail herein below with reference to the annexed drawings. In the drawings, the same or similar elements are denoted by the same reference numerals even though they are depicted in different drawings.

Additionally, in the following description made in conjunction with preferred embodiments of the present invention, a variety of specific elements such as constituent elements of various detailed circuits are shown. The description of such elements has been made only for a better understanding of the present invention. Those skilled in the art will appreciate that the present invention can be implemented without using the above-mentioned specific elements.

In the following description of the present invention, a detailed description of known functions and configurations incorporated herein will be omitted when it may obscure the subject matter of the present invention.

According to the present invention, if map data is updated in a map data server for providing map data to a navigation terminal, the server produces map modification command data and transmits the produced data to the navigation terminal. The navigation terminal receives the map modification command data from the map data server, and modifies previously stored map data according to the map modification command. Accordingly, the present invention enables the navigation terminal to update the map data by downloading a small amount of map modification command data.

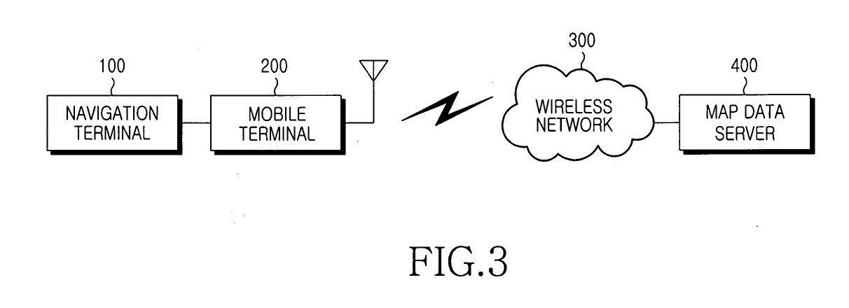

FIG. 3 is a block diagram illustrating a navigation system according to an embodiment of the present invention. As illustrated in FIG. 3, the navigation system (or a system for updating map data) according to the embodiment of the present invention includes a navigation terminal 100, a mobile terminal 200, and a map data server 400. The map data server 400 produces and stores the map information of a specific region. If specific map data, i.e., a smaller part of the entire map data, is modified, the map data server 400 produces map modification command information for the modified map data, and transmits it to a wireless network 300 after defining a version of the produced map modification command information. That is, a version of the produced map modification command information is defined by indicating the number of revisions and the latest date thereof, for determining whether the latest map has been revised. The mobile terminal 200 receives the map modification command information through the wireless network 300, and transfers it to the navigation terminal 100. The navigation terminal 100 receives the map modification command information, and modifies previously stored map data according to the map modification command.

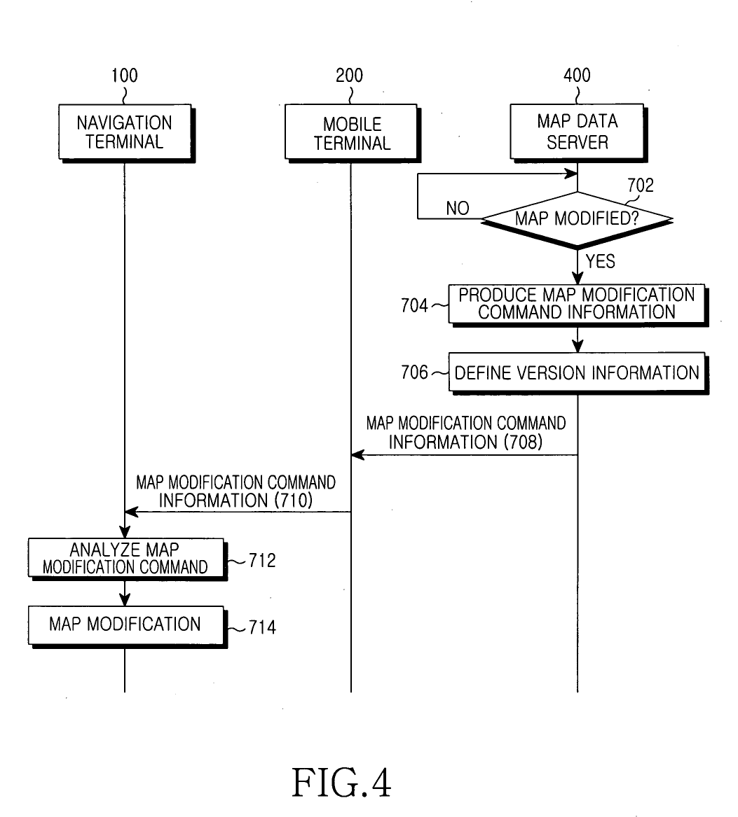

FIG. 4 is a flow chart illustrating a method for updating map data in a navigation system according to an embodiment of the present invention. At step 702, the map data server 400 determines if previously stored map data is modified. If the previously stored map data has been modified, for example, by an external server manager, the server 400 advances to step 704. At step 704, the map data server 400 produces map modification command information corresponding to the modified map data. Then, at step 706, the server 400 defines a version of the produced map modification command information produced.

After defining the version of the map modification command information, the server 400 transmits the map modification command information to the mobile terminal 200 over the wireless network 300 at step 708.

The mobile terminal 200 receives the map modification command information over the wireless network 300 and transfers the received command information to the navigation terminal 100 at step 710.

The navigation terminal 100 receives the map modification command information from the mobile terminal 200, and analyzes the received command information at step 712. Thereafter, the navigation terminal 100 modifies previously stored map data according to the analyzed map modification command information at step 714.

Accordingly, the map data update method described above enables a navigation terminal 100 to update the map data by transmitting and receiving only a small amount of map modification command information, thereby preventing high usage fees of the wireless network from being incurred.

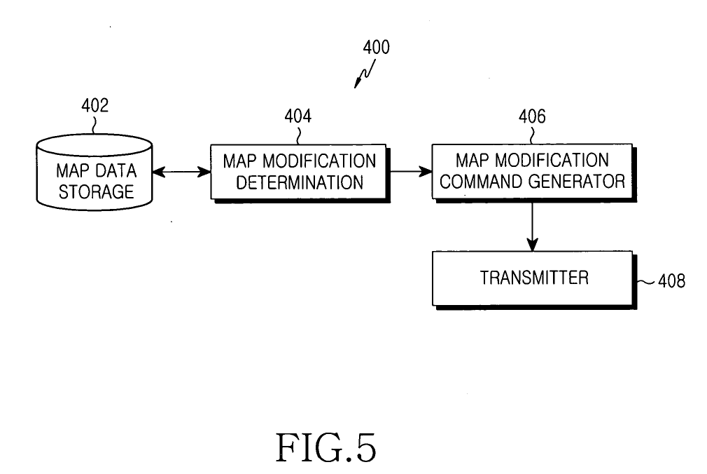

FIG. 5 is a block diagram illustrating a map data server 400 according to an embodiment of the present invention. Referring to FIG. 5, the map data server 400 includes a map data storage unit 402, a map modification determination unit 404, a map modification command generator 406, and a transmitter 408. The map data storage unit 402 stores map data, which is produced as numerical data in a specific format, for the previously acquired information of roads, buildings, facilities, etc.

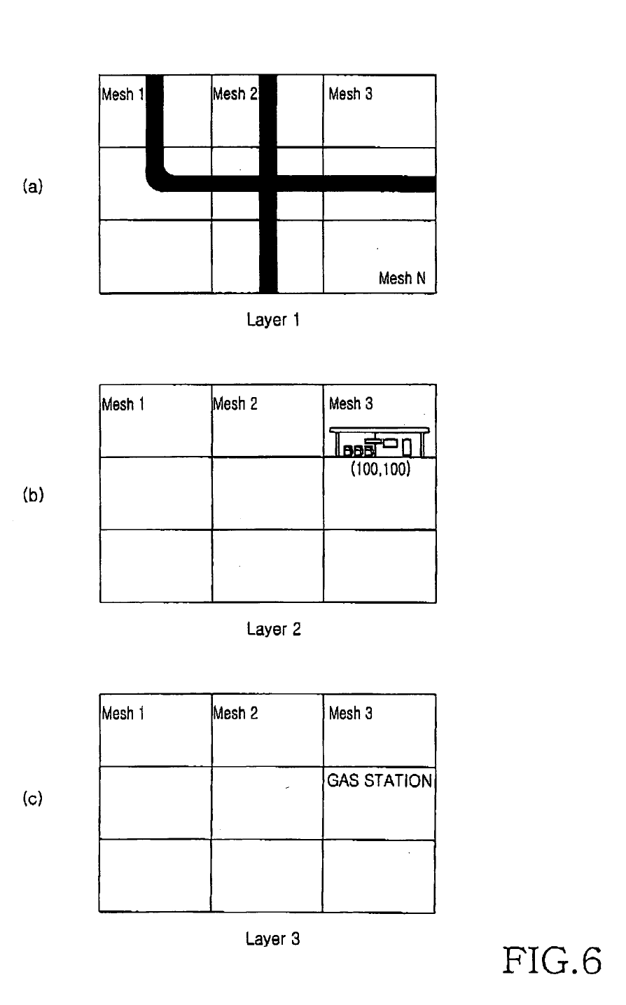

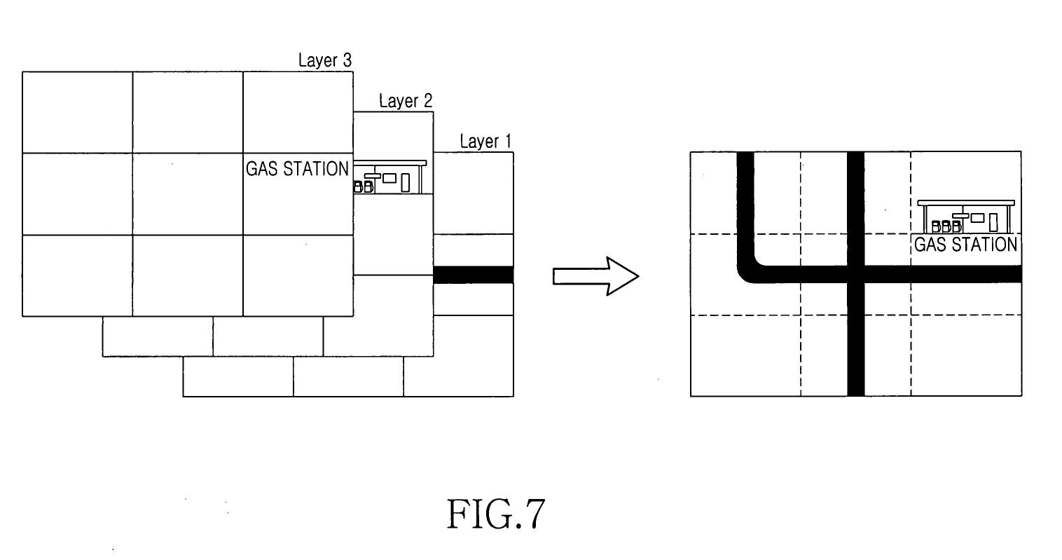

FIGS. 6 and 7 illustrate examples of the map data stored in the map data server 400 according to an embodiment of the present invention. As illustrated in FIG. 6, the map data according to the embodiment of the present invention has a mesh structure such that the map data is divided into meshes (Mesh 1-Mesh N) of a predetermined size. In addition, the map data is comprised of a plurality of layers (for example, a, b, and c) divided according to their information characteristics.

For example, in FIG. 6, (a) illustrates a first layer (Layer 1) for road information, (b) illustrates a second layer (Layer 2) for object information (for example, buildings), and (c) illustrates a third layer (Layer 3) for title information of buildings, roads, etc. The plurality of layers, divided according to their information characteristics as described above, can be combined such that they are displayed as map information on a screen. For example, if the first to third layers (Layer 1 to Layer 3) are combined together, they are displayed as illustrated in FIG. 7. As the roads, buildings, or facilities vary, an external manager may update such map data.

Returning to FIG. 5, the map modification determination unit 404 determines whether map data in the map data storage unit 402 is updated. If the external server manager has modified a part of the map data in the map data storage unit 402, the map modification determination unit 404 outputs the modified map data information.

Referring back to FIG. 5, the map modification command generator 406 produces map data modification command information based on the modified map data information output from the map modification determination unit 404. The transmitter 408 transmits the produced map data modification command information to the wireless network 300.

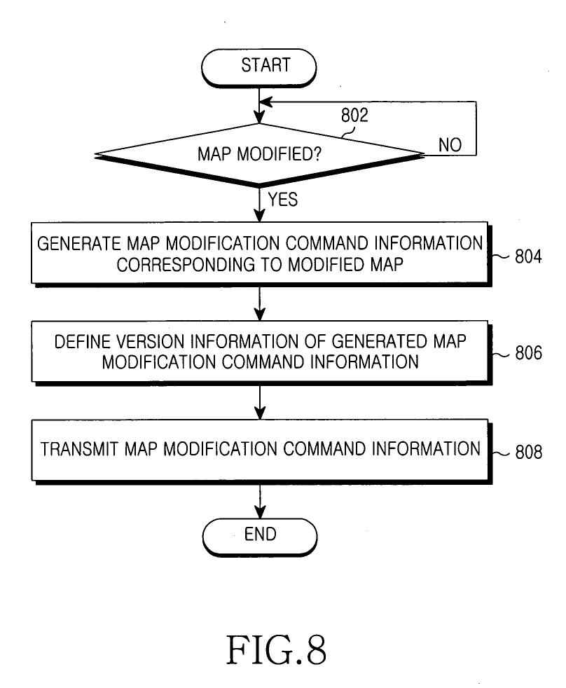

FIG. 8 is a flow chart illustrating a method for transmitting the map modification command information produced by the map data server 400 according to an embodiment of the present invention. At step 802, the map data server 400 determines, via the map modification determination unit 404, whether map data in the map data storage unit 402 is modified. If the map data has been modified, the map data server 400 produces map modification command information corresponding to the modified map data at step 804. For example, if a gas station is added to the map data at a position corresponding to a coordinate (100, 100) of a second mesh (Mesh 3) in the second layer (Layer 2) as illustrated in frame b of FIG. 6, the map data server 400 produces map modification command information. For example, the map data server produces a message that reads “add BB-4 Msh2 100,100 Obj24”. The word ‘add’ is an instruction to add a road or a structure (or an object) such as a building or a facility to the map data; ‘BB-4’ indicates that the structure to be added is an object corresponding to a fourth type (Type 4) of a group B of the object groups; ‘Msh2’ indicates a second mesh (Mesh 2); ‘100,100’ indicates a coordinate (100, 100); and ‘Obj24’ indicates that the corresponding structure is a 24th object. The ordinal number of the object is a number allocated uniquely to the internal system of each structure to discriminate the roads or buildings when making the map. That is, the information “add BB-4 Msh2 100,100 Obj24” is map modification command information to ‘add the 24th object as a fourth type object of the group B of the object groups at the position corresponding to the coordinate (100, 100) of the second mesh (Mesh 2) in the second (Layer 2) for objects (for example, buildings)’.

The following is another example. If an object (Obj24) (for example, a gas station) is deleted from a second mesh (Mesh 2) in a second layer (Layer 2) in the map data as illustrated in FIG. 6, the map data server 400 produces map modification command information such as “delete Msh2 Obj24”. The word ‘delete’ is an instruction to delete a road or an object such as a building or a facility of the map data; ‘Msh2’ indicates the second mesh (Mesh 2); and ‘Obj24’ indicates the 24th object. That is, the information “delete Msh2 Obj24” is map modification command information to ‘delete the 24th object of the second mesh (Mesh 2) in the second layer (Layer 2) for objects’.

In yet another example, if a 24th object (Obj24) of a second mesh (Mesh 2) in a second layer (Layer 2) as illustrated in FIG. 6 is changed to an object corresponding to the third type (Type 3) of the group B of the object groups, the map data server 400 produces map modification command information such as “change BB-3 Msh2 Obj24”. The word ‘change’ is an instruction to change a road or an object such as a building or a facility of the map data; ‘BB-3’ indicates an object corresponding to the third type (Type 3) of the group B of the object groups; ‘Msh2’ indicates the second mesh (Mesh 2); and ‘Obj24’ indicates the 24th object. That is, the information “change BB-3 Msh2 Obj24” is map modification command information to ‘change the 24th object of the second mesh (Mesh 2) in the second (Layer 2) for objects to the BB-3’.

After producing the map modification command information as described above, at step 806, the map data server 400 defines a version for the produced map modification command information, and adds the defined version information to the map modification command information. The version is defined to differentiate the current map modification command information from a previous one.

After adding the version information to the map modification command information, the map data server 400 transmits the map modification command information to the mobile terminal 200, connected with the navigation terminal 100, over the wireless network 300 at step 808. The mobile terminal 200 receives the map modification command information and transfers it to the navigation terminal 100.

The navigation terminal 100 analyzes the map modification command information received from the mobile terminal 200, and modifies a previously stored map on the basis of the analyzed information.

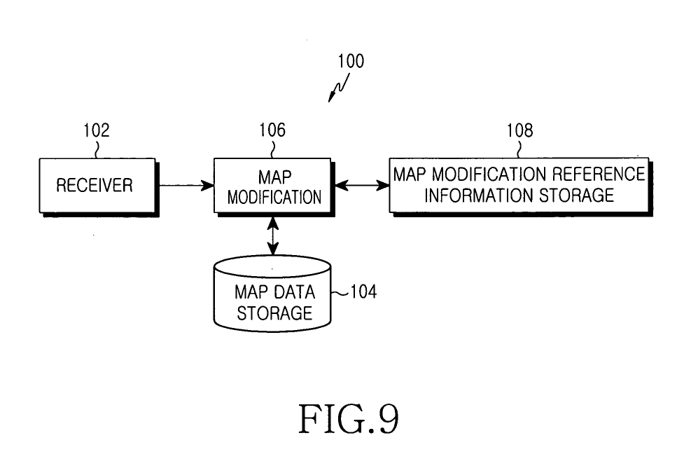

FIG. 9 is a block diagram illustrating the navigation terminal 100 according to an embodiment of the present invention. As illustrated in FIG. 9, the navigation terminal 100 includes a receiver 102, a map data storage unit 104, a map modification unit (or a map modification command analyzer) 106, and a storage unit 108 for storing map modification reference information. The receiver 102 receives map modification command information from the mobile terminal 200. The map data storage unit 104 stores map data, which has a structure similar to the map data stored in the map data storage unit 402 of the map data server 400 described above with reference to FIG. 5. The map data, stored in the map data storage unit 104 in such a manner, can be modified at the map modification unit 106.

The map modification unit 106 analyzes the map modification command information received by the receiver 102, and modifies map data previously stored in the map data storage unit 402 according to the analyzed map modification command information. If the received information includes a map modification command that employs map modification reference information, the map modification unit 106 modifies the map data according to the map modification reference information; otherwise it modifies the map data without using the map modification reference information. The map modification reference information storage unit 108 stores reference information for modifying the map.

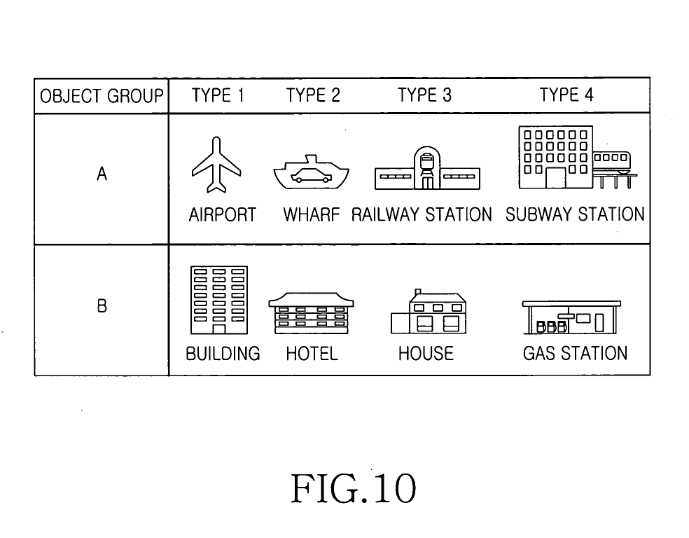

FIG. 10 illustrates an example of the map modification reference information according to an embodiment of the present invention. In FIG. 10, a number of types of objects classified according to groups. For example, a first type object of a group A of the object groups is an airport, which corresponds to map modification command information BA-1, where “B” represents a building group. A fourth type object of the group B of the object groups is a gas station, which corresponds to map modification command information BB-4. In other words, the map modification reference storage unit 108 stores a number of reference information corresponding to the map modification command as described above.

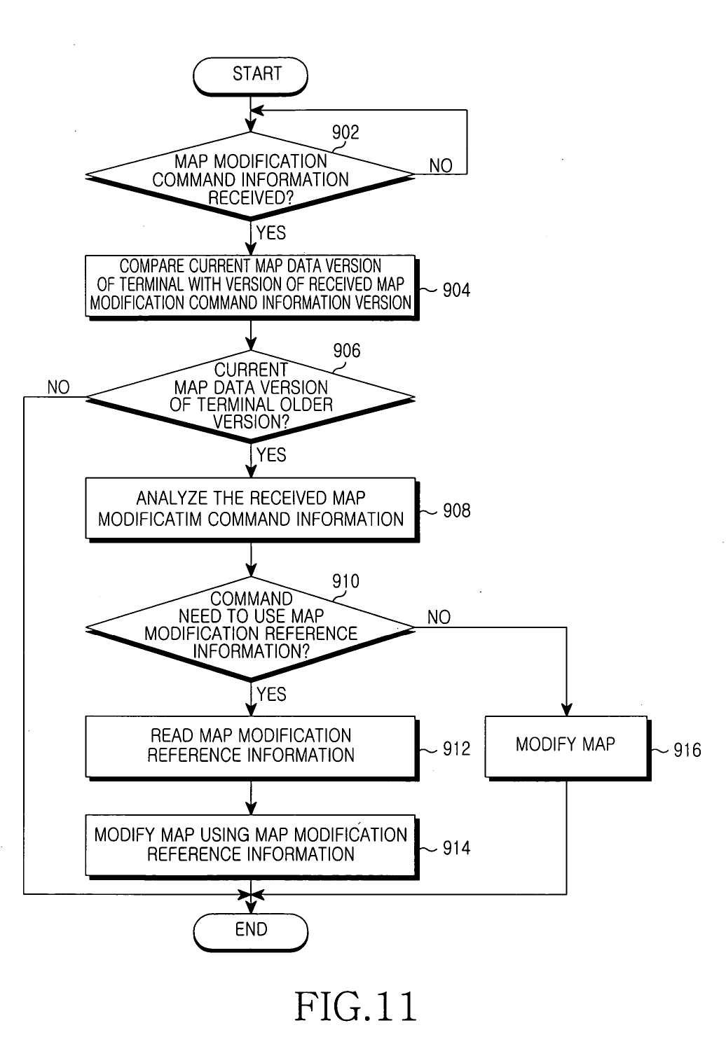

FIG. 11 is a flow chart illustrating a method for modifying map data in the navigation terminal 100 according to an embodiment of the present invention. At step 902, the navigation terminal 100 determines whether it receives map modification command information from the mobile terminal 200 via the receiver 102. If the navigation terminal 100 has received the map modification command information from the mobile terminal 200, at step 904, the navigation terminal 100 compares the version of map data currently stored in the navigation terminal 100 with the version of the received map modification command information. At step 906, the navigation terminal 100 determines whether the version of the current map data stored in the navigation terminal 100 is older than the version of the received map modification information.

If the version of the current map data stored in the navigation terminal 100 is not older than the version of the received map modification command information, the navigation terminal 100 terminates the map data update process. However, if the version of the current map data stored in the navigation terminal 100 is older than the version of the received map modification command information, the navigation terminal 100 analyzes the received map modification command information at step 908.

For example, if the received map modification command information is “delete Msh2 Obj24”, the navigation terminal 100 analyzes it as an instruction to ‘delete the 24th object of the second mesh in the second layer for objects’. In addition, if the received map modification command information is “change BB-3 Msh2 Obj24”, the navigation terminal 100 analyzes it as an instruction to ‘change the 24th object of the second mesh in the second layer for objects to a BB-3 object’.

After analyzing the received map modification command information as described above, the navigation terminal 100 determines, at step 910, whether the received information includes a map modification command for which there is a need to use the map modification reference information. If the received map modification command information includes a map modification command for which there is no need to use the map modification reference information (i.e., if there is no need to use the map modification reference information), the navigation terminal 100 modifies the map as analyzed at step 916. For example, if the map modification command information includes a command such as “delete Msh2 Obj4” for which there is no need to use the map modification reference information, the navigation terminal 100 deletes the 24th object of the second mesh in the second layer for objects, as analyzed at step 916.

However, if the received map modification information includes a command that needs to use the map modification reference information, to step 912, the navigation terminal 100 reads the needed map modification reference information from the map modification reference information storage unit 108. For example, if the received map modification command information includes a command, such as “change BB-3 Msh2 Obj24”, for which there is a need to use the map modification command reference information of ‘BB-3’, the navigation terminal 100 reads the information of ‘BB-3’ among the map modification command reference information stored in the map modification reference storage unit 108.

After reading the needed map modification reference information in such a manner, the navigation terminal 100 modifies the map data stored in the map data storage unit 104 using the read map modification reference information at step 914. For example, using the map modification command reference information of ‘BB-3’, the navigation terminal 100 changes the 24th object of the second mesh in the second layer for objects to a BB-3 object.

As described above, the present invention enables the navigation terminal 100 to modify the map data using the map modification command information that has a data amount significantly smaller than the prior art.

As is apparent from the above description, according to the present invention, when an external manager updates the map data, a map data server for providing map data produces map modification command data, and transmits it to a navigation terminal. The navigation terminal receives and analyzes the map modification command data, and modifies map data previously stored in the terminal according to the received map modification command. Thus, the present invention has an advantage in that it can update map data using a small amount of map modification command data. It is also possible for the navigation terminal to prevent high usage fees of the wireless network from being incurred when using the wireless network to update the map data, because the navigation terminal modifies the map data using the small amount of map modification command data.

Although preferred embodiments of the present invention have been disclosed for illustrative purposes, those skilled in the art will appreciate that various modifications, additions, and substitutions are possible, without departing from the scope and spirit of the invention as disclosed in the accompanying claims.

1. A navigation system comprising:
a map data server for storing map data of a specific region, and producing and transmitting map modification command information corresponding to modified map data for a portion of the specific region; and
a navigation terminal for storing the map data stored in the map data server, receiving the map modification command information, and modifying the stored map data according to the map modification command information.

2. The system according to claim 1, wherein the modified map data is provided from an external manager.

3. The system according to claim 1, wherein the map data server comprises:
a map data storage unit for storing the map data in a predetermined format, the map data corresponding to real map information;
a map modification determination unit for determining if the map data is updated, and outputting information of updated map data, if the map data is updated;
a map modification command information generator for generating the map data modification command information, based on the information of the updated map data; and
a transmitter for transmitting the map data modification command information.

4. The system according to claim 1, wherein the map data is divided into a plurality of meshes of a predetermined size, and the map data includes one or more layers divided according to respective information characteristics of the layers.

5. The system according to claim 1, wherein the map data includes at least two layers divided according to respective information characteristics of the at least layers.

6. The system according to claim 1, wherein the navigation terminal comprises:
a receiver for receiving the map modification command information;
a map data storage unit for storing the map data, the map data being modified according to the received map modification command information; and
a map modification unit for analyzing the received map modification command information, and modifying the map data stored in the map data storage unit according to the analyzed result of the received map modification command information.

7. The system according to claim 6, wherein the navigation terminal further comprises a map modification reference information storage unit for storing reference information required for modifying the map data.

8. The system according to claim 7, wherein the map modification unit modifies the map data stored in the map data storage unit using the reference information, according to the analyzed result of the received map modification command information.

9. The system according to claim 7, wherein the reference information is object information having at least two types of objects classified according to groups.

10. A method for updating map data in a navigation system, comprising the steps of:
determining if previously stored map data is updated;
if the map data has been updated, generating map modification command information corresponding to updated map data;
transmitting the map modification command information;
receiving the map modification command information; and
modifying the previously stored map data in the navigation terminal according to the received map modification command information.

11. The method according to claim 10, further comprising the step of defining version information of the generated map modification command information.

12. The method according to claim 11, further comprising the steps of:
analyzing the received map modification command information; and
terminating the update method, if the analyzed result of the received map modification command information is that the version of the received map modification command information is older than a version of the map data previously stored in the navigation terminal.

13. The method according to claim 10, wherein the step of modifying the previously stored map data comprises the steps of:
determining if the received map modification command information includes a map modification command for which there is a need to use map modification reference information; and
if the map modification reference information is needed, modifying map data using map modification reference information corresponding to the map data.
